(19) United States
(12) Patent Application Publication
(10) Pub. No.: US 2026/0244143 A1
(43) Pub. Date: Aug. 20, 2026

(54) SYSTEMS AND METHODS FOR FUSER HEALTH MONITORING

(71) Applicant: Xerox Corporation, Norwalk, CT (US)

(72) Inventors: David S. Derleth, Webster, NY (US); Anthony S. Condello, Webster, NY (US); Nicolas Celestino Pietrantoni, Webster, NY (US); Matthew Atvell, Rochester, NY (US); Eliud Robles Flores, Rochester, NY (US)

(21) Appl. No.: 19/057,196

(22) Filed: Feb. 19, 2025

(51) Int. Cl. G03G 15/00; B08B 1/14; B08B 1/30; G03G 15/20

(52) U.S. Cl. CPC G03G 15/55; B08B 1/143; B08B 1/30; G03G 15/2025; G03G 15/5079

(57) ABSTRACT

Systems and methods for operating a system including one or more machines. The methods comprise: obtaining, by a processor, one or more temperature readings taken during at least one print job performed by the machine(s); detecting, by the processor, a fuser fault based on the one or more temperature readings and at least one of a nominal run temperature for a heating roller of a fuser and an expected temperature range for a fuser roller of the fuser; and taking, by the processor, a maintenance action to resolve the detected fuser fault.

### BACKGROUND

### Description of the Related Art

Print engines today are expected to be smart, self-healing, or—at the very least—predictive, for example, to warn the customer, service representative and/or printer manufacturer of potential issues. This is especially true around fusers. Fusers are crucial parts of the printing engines. A bad or defective fuser or fuser batch is undesirable in most applications.

### SUMMARY

The present disclosure concerns implementing systems and methods for operating a system including one or more machines, comprising: obtaining, by a processor, one or more temperature readings taken during at least one print job performed by the one or more machines; detecting, by the processor, a fuser fault based on the one or more temperature readings and at least one of a nominal run temperature for a heating roller of a fuser and an expected temperature range for a fuser roller of the fuser; and taking, by the processor, a maintenance action to resolve the detected fuser fault.

The present disclosure also concerns a system, comprising: one or more machines having fusers installed therein and temperature sensors that take temperature readings during print or copy jobs; a processor; and a non-transitory computer-readable medium comprising one or more programming instructions that when executed by the processor, cause the processor to: obtain one or more temperature readings taken during at least one print or copy job performed by the one or more machines; detect a fuser fault based on the one or more temperature readings and at least one of a nominal run temperature for a heating roller of a fuser and an expected temperature range for a fuser roller of the fuser; and take a maintenance action to resolve the detected fuser fault.

### BRIEF DESCRIPTION OF THE DRAWINGS

The present solution will be described with reference to the following drawing figures, in which like numerals represent like items throughout the figures.

FIG. 1 provides an illustration of a system implementing the present solution.

FIG. 2 provides an illustration that is useful for understanding nominal or expected temperatures of a fuser roller and heating rollers of a machine.

FIG. 3 provides a table showing fuser temperature settings for the fuser roller and heating rollers of the machine.

FIG. 4 provides a graph showing an expected fuser temperature log.

FIG. 5 provides a graph showing a fuser temperature log indicating a fault.

FIGS. 6A-6C (collectively referred to as FIG. 6”) provides a flow diagram of an illustrative method for operating a system implementing the present solution.

FIG. 7 (collectively referred to as FIG. 7”) provides a flow diagram of an illustrative method for operating a system implementing the present solution.

FIG. 8 provides a block diagram of an illustrative architecture for a computing device.

### DETAILED DESCRIPTION

Xerographic devices are configured to produce an image by applying a marking material (e.g., toner or ink jet ink) to a latent image on a photoreceptor. A transfer device transfers the developed marking material to a media sheet or image transfer belt to provide a developed image. A fuse assembly then affixes or fuses the developed image to the media sheet by applying heat and/or pressure to the media sheet. Service engineers replace components (e.g., photoreceptors) at a specific interval even if the xerographic device is still performing acceptably. System run costs can be reduced by extending the life of the components to their near failure points, instead of replacing them at a fixed interval.

Current methods for predicting failures in most print engines lack ‘smartness’. This is not due to insufficient data but rather because the data is very complicated and convoluted. The field may have hundreds or thousands of machines producing data under varied circumstances. The workload falls on engineers and service technicians to realize the Inception of something bad happened, when is mostly too late: the field Impact is evident, the Symptoms are real, and the Result is obvious.

The present solution provides a novel technique to predict that an issue is going to occur in the future based on measured fuser temperature data. Understanding the relationship of the temperature signatures within the fuser to know failure modes allows corrective action to be taken prior to the machine not functioning properly. For example, the machine may raise a status message to alert service is required during the next visit to prevent the machine from being un-operational requiring an additional service call. This provides a way to avoid machine down time and/or reduce the number of service calls. Customer output is maximized since there will be less machine down time and service calls. The particulars of the novel technique will become evident as the discussion progresses.

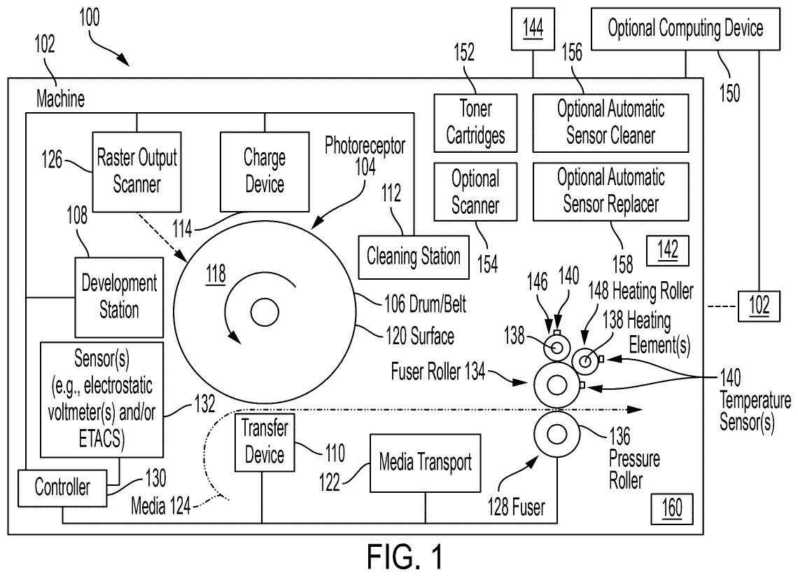

FIG. 1 provides an illustration of a system 100 implementing the present solution. System 100 comprises one or more machines 102 with a media transport 122. The term “machine”, as used herein, refers to a device whose performance is being monitored. Each machine can include, but is not limited to, a xerographic print engine, a xerographic printer, a xerographic multifunction media device, a xerographic machine, or other xerographic device that produces images on media sheets. The media sheets can include, but are not limited to, paper, substrates, transparencies, plastic, cardboard, and/or other media sheets.

The media transport 122 is configured to transport media or an intermediate transfer belt or drum 124. Machine 102 may also comprise a photoreceptor 104. The photoreceptor 104 can be a belt or drum 106 and have a photoreceptor charge transport surface 120 for forming electrostatic images thereon. The photoreceptor 104 is configured to rotate in the direction shown by arrow 118 and generate an image on the media sheet(s) being transported by the media transport's belt or drum 124.

Machine 102 also comprises a charger device 114 that can apply a first voltage V₁ to the photoreceptor 104. Charger device 114 can include, but is not limited to, a scorotron, a charge roll, or any other electric field generation device. The charger device 114 is configured to impart an electrostatic charge on the surface 120 as the photoreceptor 104 rotates.

A raster output scanner 126 is configured to discharge selected areas of the photoreceptor surface 120 according to the desired image to be printed. The selected portions of the photoreceptor surface 120 can be discharged to a lower second voltage V₂. The raster output scanner 126 can include, but is not limited to, a laser source, a rotatable mirror, light-lens system, and/or a Light Emitting Diode (LED) bar.

A development station 108 is configured to develop an exposed latent image by applying a third voltage V₃ after selected areas of the photoreceptor surface 120 are discharged. The third voltage may have a magnitude in between V₁ and V₂. The application of the third voltage V₃ causes a supply of marking material to contact or otherwise approach the exposed latent image on the photoreceptor surface 120. The marking material can include, but is not limited to, toner or ink jet ink.

A transfer device 110 transfers the developed marking material to a media sheet or image transfer belt to provide a developed image. In this regard, the transfer device 110 is configured to cause the marking material adhering to the photoreceptor surface 120 to be electrically transferred to media (e.g., the media sheet(s) or to the intermediate transfer belt or drum 124) to form the image thereon. The media with the toner image thereon can then be passed through a fuser 128.

Fuser 128 is configured to cause the marking material to melt or fuse into the media to create the permanent image. This can be achieved through the application of heat and/or pressure to the media sheet by rollers 134, 136. Roller 134 may be referred to herein as a fuser roller and/or a heated roller, while roller 136 may be referred to herein as a pressure roller. Fuser roller 134 is heated by heating rollers 146, 148. The pressure roller 136 holds the media firmly against the fuser roller 134 when the toner melts and adheres to the media. The heat and pressure may also cause the toner to melt and be pressed into media fibers.

Once the image is fused or permanently fixed to the sheet of media, a gate either allows the sheet to move directly via an output to a finisher or stacker, or deflects the sheet of media into a duplex path (not shown for ease of illustration).

After the copy sheet is separated from the photoconductive surface 120, cleaning station 112 is used to clean any residual marking material and/or paper from the photoconductive surface 120. The cleaning station 112 can include, but is not limited to, electrostatic cleaning brush(es) coupled to the photoreceptor surface 120, or a rubber cleaning blade in contact with the photoreceptor surface 120 to scrape any residual toner and/or paper from the photoreceptor surface. The photoreceptor surface 120 may be cleaned, for example, using an electric field generated between the fibers of the electrostatic cleaning brush(es) and the residual toner on the photoreceptor surface.

A controller 130 is provided to control operations of machine 102. In this regard, controller 130 is electrically connected to components 104, 108-114, 122-128 of machine 102. Controller 130 is configured to predict upcoming issues with the machine (e.g., temperature sensor fault or failure) based on certain criteria. The controller 130 may also be configured to output an indicator that indicates the predicted issue and/or the need for an upcoming service. The indicator can be output visually, tactically or auditorily.

Controller 130 controls operations of the heating elements 138 within the heating rollers 146, 148 based on the temperature of the fuser roller 134. The heating elements can include, but are not limited to, lamps. Temperature sensor(s) 140 is(are) provided in rollers 134, 146, 148 of machine 102 to facilitate such control by controller 130. Any known or to be known temperature sensor can be used here. For example, the temperature sensor(s) 140 comprise(s) contact and/or non-contact thermistor(s) which is(are) used to determine whether more or less energy is needed to maintain a fuser roll set point. The temperature sensor(s) 140 is(are) configured to read or measure the temperature of the roller(s) 134, 146, 148. It should be noted that the temperatures of the heating rollers 146, 148 are set to a set point at the start of a print job and then adjusted by the controller to maintain the surface temperature of the fuser roller 134 at its set point and/or within a range of its set point.

The temperature readings or measurements may be stored in a local datastore 142 and/or remote datastore 144. The temperature readings or measurements may also be communicated from sensors 140 to controller 130 for analysis. The datastore(s) can include, but are not limited to, non-volatile memory and/or database. The remote database 144 may be accessed via a network (not shown for ease of illustration) (e.g., the Internet or Intranet).

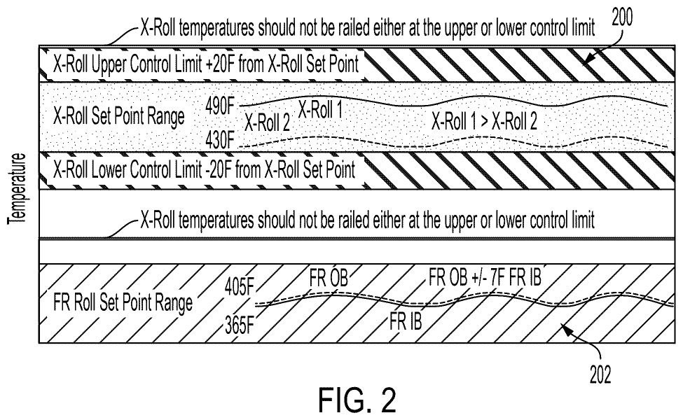

It should be noted here that there are two heating rollers shown in FIG. 1. Heating roller 146 may be referred to as a first external roll (X-Roll 1), while heating roller 148 may be referred to as a second external roll (X-Roll 2). FIG. 2 provides an illustration that is useful for understanding nominal temperatures of the rollers. As shown in an upper portion 200 of FIG. 2, the nominal or expected temperature for X-Roll 1 and X-Roll 2 may be at or between 430° F. or 490° F. depending on the characteristics of what is being run through the fuser 128 (e.g., light weight paper, heavy weight paper, number of toner layers, number of passes or toner, etc.). The set points for the heating rollers will change based on the media being run through fuser 128. The two heating rollers 146, 148 will have the same set point at any given time. X-Roll 2 is the first heating roller that the fuser roller 134 will encounter as it rotates. Therefore, more energy is drawn from X-Roll 2 than X-Roll 1 by fuser roller 134.

As shown in a lower portion 202 of FIG. 2, fuser roller 134 has a nominal set point that can range between 365° F. and 405° F. depending on the characteristics of what is being run through the fuser 128 (e.g., light weight paper, heavy weight paper, number of toner layers, number of passes or toner, etc.). There are two temperature sensors 140 on the fuser roller 134. A first temperature sensor is on the inboard (IB) side, while a second one is on the outboard (OB) side. The first temperature sensor may be referred to as “the FR IB sensor” and the second temperature sensor may be referred to as “the FR OB sensor”. The temperature readings of the FR IB sensor and the FR OB sensor should ideally be close to each other. For example, the temperature reading of the FR OB sensor should be within ±7° F. of the temperature reading of the FR IB sensor. If controller 130 detects abnormal temperature readings that could potentially create a problem in machine 102, then the system can proactively take one or more maintenance actions. Abnormal temperature readings may be detected, for example, when the temperature reading of the FR IB sensor is not within ±7° F. of the temperature reading of the FR OB sensor.

The maintenance actions can include, but are not limited to: notifying or alerting a service representative or technician that the fuser 128 in a particular machine should be serviced; transitioning an operational state of the machine 102 from an ON state to an OFF state or from a print mode to a standby mode; enabling a self-cleaning mode of the fuser 128 to initiate operations for cleaning the temperature sensor(s) 140; automatically changing distance(s) between heating roller(s) and fuser roller; adjusting alignment between a heating roller and the fuser roller to ensure that they are properly spaced; and/or adjusting alignment between a heating roller and the fuser roller so that a same or constant distance exists therebetween along their entire lengths. The self-cleaning mode operations can include, but are not limited to: increasing the temperature of the fuser roller 134; adjusting a rotational speed (e.g., decrease or increase) of one or more rollers 134, 146, 148; automatically moving one or more temperature sensor(s) into the media path; and/or controlling an automatic sensor cleaner 156 for cleaning the temperature sensor(s) 140 of the fuser roller 134, heating roller 146 and/or heating roller 148.

The maintenance actions can additionally or alternatively include: controlling an automatic sensor replacer 158 to switch out temperature sensor(s) associated with the abnormal temperature reading(s) from the fuser circuit and switch in other temperature sensor(s) into the fuser circuit; and/or (re)calibrating the fuser by shifting up or down the nominal or expected temperatures for one or more rollers 134, 146, 148 and/or enabling a software function configured to add and/or subtract given value(s) from temperature readings of the roller(s) 134, 146, 148 associated with the abnormal readings. The automatic sensor cleaner 156 is generally configured to wipe an external surface of one or more temperature sensors with a material (e.g., a piece of felt or other fabric that may or may not be coated with a film remover). The automatic sensor cleaner 156 can include, but is not limited to, motor(s), gear(s), shaft(s), post(s), resilient biasing member(s) (e.g., spring(s)), robotic or articulating arm(s), and/or cloth covered distal fee end(s). The automatic sensor replacer 158 is generally configured to, for example, actuate a switch for switching in/out temperature sensor(s) from the fuser circuit, and/or actuating electro-mechanical component(s) and/or mechanical component(s) to move temperature sensor(s) closer to and/or farther from a given roller 134, 146, 148. Any known or to be known electronic, mechanical and/or electro-mechanical switch can be used here. Also, any known or to be known electro-mechanical component(s) and/or mechanical component(s) for moving objects to/from different positions can be used here.

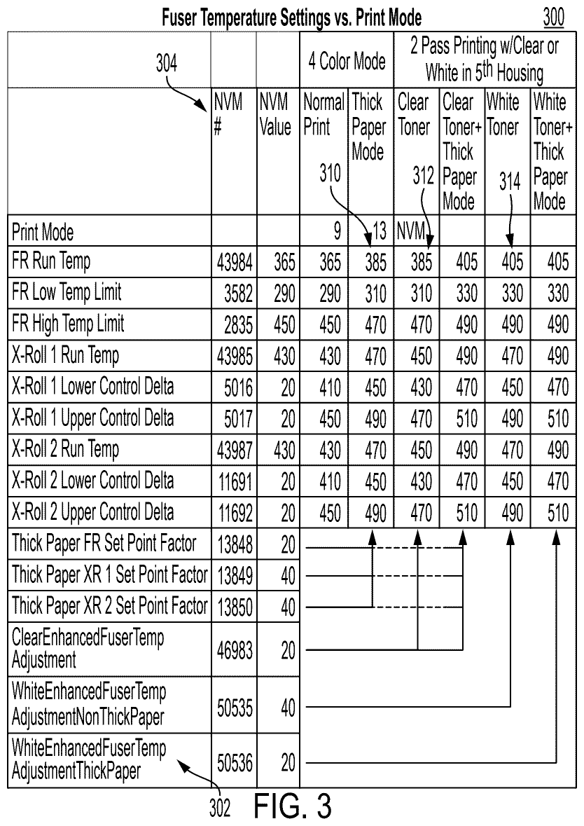

FIG. 3 provides a table 300 showing illustrative fuser temperature settings and variations thereto that are expected during a print mode of operation. Table 300 includes a plurality of rows 302 and columns 304. First rows entitled FR Run Temp, FR Low Temp Limit and FR High Temp Limit include values for the fuser roller 134. Second rows entitled X-Roll 1 Run Temp, X-Roll 1 Lower Control Delta, X-Roll 1 Upper Control Delta include values for the heating roller (X-Roll 1) 146. Third rows entitled X-Roll 2 Run Temp, X-Roll 2 Lower Control Delta, X-Roll 2 Upper Control Delta include values for the heating roller (X-Roll 2) 148.

The FR Run Temp row has a non-volatile memory (NVM) Value associated therewith indicating a set point of 365° F. for the fuser roller 134. The FR Low Temp Limit row has an NVM Value associated therewith indicating a low-limit temperature of 290° F. for the fuser roller 134. The FR High Temp Limit row has an NVM Value associated therewith indicating a high-limit temperature of 450° F. for the fuser roller 134. If controller 130 and/or computing device 150 detects a temperature reading below 290° F. or above 450° F., then it concludes a fault condition exits for fuser roller 134.

The X-Roll 1 Run Temp row has an NVM Value associated therewith indicating a nominal or average temperature of 430° F. for heating roller (X-Roll 1) 146. The X-Roll 1 Lower Control Delta has an NVM Value of 20° F. and the X-Roll 1 Upper Control Delta has an NVM Value of 20° F., which means the temperature of the heating roller (X-Roll 1) 146 is expected to be between 410° F. and 450° F. A temperature reading for heating roller (X-Roll 1) 146 that falls outside of this range 410° F.-450° F. indicates a fault condition.

The X-Roll 2 Run Temp row has an NVM Value associated therewith indicating a nominal or average temperature of 430° F. for heating roller (X-Roll 1) 146. The X-Roll 2 Lower Control Delta has an NVM Value of 20° F. and the X-Roll 2 Upper Control Delta has an NVM Value of 20° F., which means the temperature of the heating roller (X-Roll 2) 148 is expected to be between 410° F. and 450° F. A temperature reading for heating roller (X-Roll 2) 148 that falls outside of this range 410° F.-450° F. indicates a fault condition.

The fourth rows entitled Thick Paper FR Set Point Factor, Thick Paper XR 1 Set Point Factor, Thick Paper XR 2 Set Point Factor, ClearEnhancedFuserTempAdjustment, WhiteEnhancedFuserTempAdjustmentNonThickPaper, and WhiteEnhancedFuserTempAdjustmentThickPaper provide adjustments to the above temperature values for different scenarios. Specifically, the Thick Paper FR Set Point Factor, Thick Paper XR 1 Set Point Factor and Thick Paper XR 2 Set Point Factor are associated with the scenario in which heavy weight or thick paper is run through the fuser. In this case, the FR Run Temp is increased by 20° F. to 385° F. as shown in cell 310 of table 300. The FR Low Temp Limit is increased by 20° F. to 310° F. The FR High Temp Limit is increased by 20° F. to 470° F. The X-Roll 1 Run Temp and X-Roll 2 Run Temp are increased by 40° F. to 470° F. The X-Roll 1 Lower Control Delta, X-Roll 1 Upper Control Delta, X-Roll 2 Lower Control Delta, and X-Roll 2 Upper Control Delta are adjusted accordingly.

The ClearEnhancedFuserTempAdjustment row is associated with the scenario in which a clear toner is disposed on top of a fused color (CMYK) print. In this case, the FR Run Temp is increased by 20° F. from the normal print value of 365° F. to 385° F. as shown by cell 312 of table 300. The FR Low Temp Limit is increased by 20° F. to 310° F. The FR High Temp Limit is increased by 20° F. to 470° F. The X-Roll 1 Run Temp and X-Roll 2 Run Temp are increased by 20° F. from the normal print value of 430° F. to 450° F. The X-Roll 1 Lower Control Delta, X-Roll 1 Upper Control Delta, X-Roll 2 Lower Control Delta, and X-Roll 2 Upper Control Delta are adjusted accordingly.

In the scenario that (i) heavy weight or thick paper is run through the fuser and (ii) clear toner is disposed on top of a fused color print, the FR Run Temp is increased by 40° F. (i.e., 20° F.+20° F.) from the normal print value of 365° F. to 405° F. as shown by cell 314 of table 300. The FR Low Temp Limit, FR High Temp Limit, X-Roll 1 Run Temp, X-Roll 2 Run Temp, X-Roll 1 Lower Control Delta, X-Roll 1 Upper Control Delta, X-Roll 2 Lower Control Delta, and X-Roll 2 Upper Control Delta are adjusted accordingly.

The WhiteEnhancedFuserTempAdjustmentNonThickPaper row and WhiteEnhancedFuserTempAdjustmentThickPaper row are associated with the scenario in which white toner is disposed on dark media and fused. CMYK toner is then applied to the fused print. The temperature values for these scenarios are shown in table 300.

Controller 130 and/or computing device 150 use actual temperature data for the fuser roller 134 and actual temperature data for an external roller 146, 148 to monitor the roller temperature of the machine 102. The monitoring may involve: (i) determining whether an actual temperature reading for X-roll 1 146 is equal to or greater than X-roll 1 Run Temp plus X-roll 1 Upper Control Delta (e.g., 450° F.=430° F. +20° F.); and (ii) determining whether an actual temperature reading for X-roll 2 148 is equal to or greater than X-roll 2 Run Temp plus X-roll 2 Upper Control Delta (e.g., 450° F.=430° F. +20° F.). These determination operations may be defined by the following mathematical equations (1) and (2).

$${T}_{XR 1 actual} \geq {T}_{XR 1 runtemp} + {T}_{XR 1 uppercontroldelta} \qquad ( 1 )$$

$${T}_{XR 2 actualtemp} \geq {T}_{XR 2 runtemp} + {T}_{XR 2 uppercontroldelta} \qquad ( 2 )$$

where T_{XR1actual} represents an actual temperature reading for an X-roll 1, T_{XR1runtemp} represents a run temperature for an X-roll 1, T_{XR1uppercontroldelta} represents an upper control delta for an X-roll 1, T_{XR2actualtemp} represents an actual temperature reading for an X-roll 2, T_{XR2runtemp} represents a run temperature for an X-roll 2, T_{XR2uppercontroldelta} represents an upper control delta for an X-roll 2. If the criteria of mathematical equations (1) and/or (2) is/are met, then the controller 130 and/or computing device 150 may perform one or more maintenance actions. For example, the controller 130 and/or computing device 150 may raise a flag, log a fault, issue a message to an individual to check and/or adjust the nip width between heating roller(s) 146, 148 and the fuser roller 134, automatically adjust (increase or decrease) the nip width, and/or automatically clean or replace the temperature sensor(s) 140 of the fuser roller 134. The term “nip width” as used here refers to the distance between a heating roller and a fuser roller. Any known or to be known technique for adjusting the nip width can be used here. The present solution is not limited to the listed maintenance actions. Other or different maintenance actions may be taken by controller 130 and/or computing device 150 when the criteria of mathematical equations (1) or (2). Various maintenance actions are discussed above.

Additionally or alternatively, the monitoring may involve (iii) determining whether an actual temperature reading for X-roll 1 146 is equal to or lower than X-roll 1 Run Temp minus X-roll 1 Lower Control Delta (e.g., 410° F.=430° F.-20° F.); and (iv) determining whether an actual temperature reading for X-roll 2 148 is equal to X-roll 2 Run Temp minus X-roll 2 Lower Control Delta (e.g., 410° F.=430° F.-20° F.). These determination operations may be defined by the following mathematical equations (3) and (4).

$${T}_{XR 1 actualtemp} \leq {T}_{XR 1 runtemp} - {T}_{XR 1 uppercontroldelta} \qquad ( 3 )$$

$${T}_{XR 2 actualtemp} \leq {T}_{XR 2 runtemp} - {T}_{XR 2 uppercontroldelta} \qquad ( 4 )$$

where T_{XR1lowercontroldelta} represents a lower control delta for an X-roll 1, and T_{XR2lowercontroldelta} represents a lower control delta for an X-roll 2. If the criteria of mathematical equations (3) and/or (4) is/are met, then the controller 130 and/or computing device 150 may perform one or more maintenance actions. For example, the controller 130 and/or computing device 150 may raise a flag, log a fault, issue a message to individual(s) to check the nip width between the heating roller(s) 146, 148 and the fuser roller 134, and/or clean or replace the temperature sensor(s) 140 of the fuser roller 134 and the X-roll 1 48. The present solution is not limited to the listed maintenance actions. Other or different maintenance actions may be taken by controller 130 and/or computing device 150 when the criteria of mathematical equations (1) or (2). Various maintenance actions are discussed above.

Additionally or alternatively, the monitoring may involve (v) determining whether an actual FR IB temperature is not within a threshold range of the actual FR OB temperature reading. The threshold range may be selected in accordance with a given application. For example, the threshold range can be selected to be ±7 FR OB temperature. This determination operation may be defined by the following mathematical equations (5).

$${T}_{FROB} - v \leq {T}_{FRIB} \leq {T}_{FROB} + v \qquad ( 5 )$$

where T_{FRIB} represents an actual FR IB temperature, T_{FROB} represents an actual FR OB temperature, and v represents a specified value. If the criteria of mathematical equation (5) is not met, then the controller 130 and/or computing device 150 may perform one or more maintenance actions. For example, the controller 130 and/or computing device 150 may raise a flag, log an fault, issue a message, clean or replace the temperature sensor(s) 140 of the fuser roller 134, check X-roll to fuser roller nip uniformity, and/or verify the fuser roller and heating element(s) 138 (e.g., lamps) are working properly.

If any of the above conditions exist in more than N machines 102 with the same fuser roller batch or lot (enabled via scanner 154), then the controller 130 and/or computing device 150 may perform one or more maintenance actions. For example, the controller 130 and/or computing device 150 may raise a flag, issue a message to individual(s) to investigate a possible bad batch of consumables, and/or control robotic systems 160 to automatically replace the fusers in the N machines. N is an integer equal to or greater than one. Robotic systems 160 can include, but are not limited to, articulating arms configured to retrieve a fuser from a storage compartment.

Other sensors 132 may be provided to obtain voltage based bare belt readings that may be used for various reasons by controller 130 (e.g., to detect, predict, notify, warn, prevent and/or remove a bad batch of drum/belts 106 and/or toner cartridges 152 in the field). The bare belt readings may be made by voltage measuring devices (such as electrostatic voltmeters (ESVs)) and/or extended toner area coverage sensors (ETACSs). Any known ESV and/or ETACS can be used here. An ESV measures the voltage potential of control patches on a photoconductive surface of the belt or drum. An example of an ESV is described in U.S. Pat. No. 6,426,630 to Werner, Jr. The ETACS sensors can include, but are not limited to, light sensors. The bare belt readings may be made by an ETAC in a location labeled as “background patch”. The bare belt readings may be stored in datastore(s) 142, 144.

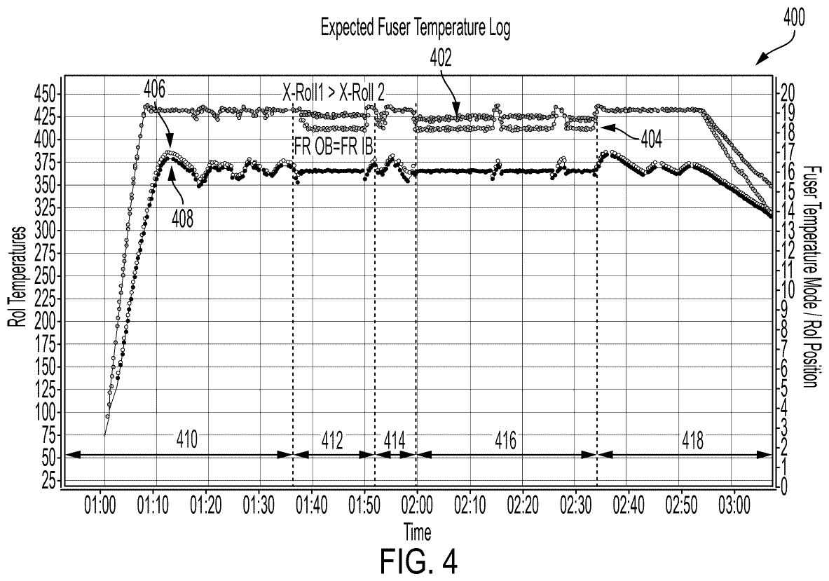

FIG. 4 provides graph 400 showing an expected fuser temperature log. Line 402 plots temperature readings for heating roller (X-Roll 1) 146, while line 404 plots temperature readings for heating roller (X-Roll 2) 148. Heating roller (X-Roll 2) 148 has a tendency to run cooler than heating roller (X-Roll 1) 146. Line 406 plots FR OB temperature readings for fuser roller 134, while line 408 plots FR IB temperature readings for fuser roller 134.

During time periods 412 and 416, machine 102 is operating in print mode. Machine 102 is operating in a standby mode during the time periods 410, 414, 418. While in standby mode, the temperatures of the heating rollers should be the same or substantially similar. However, in print mode, the temperature of heating roller (X-Roll 2) 148 is lower than the temperature of heating roller (X-Roll 1) 146. With regard to the fuser roller 134, the FR OB temperature and FR IB temperature are equal when the machine is in print mode.

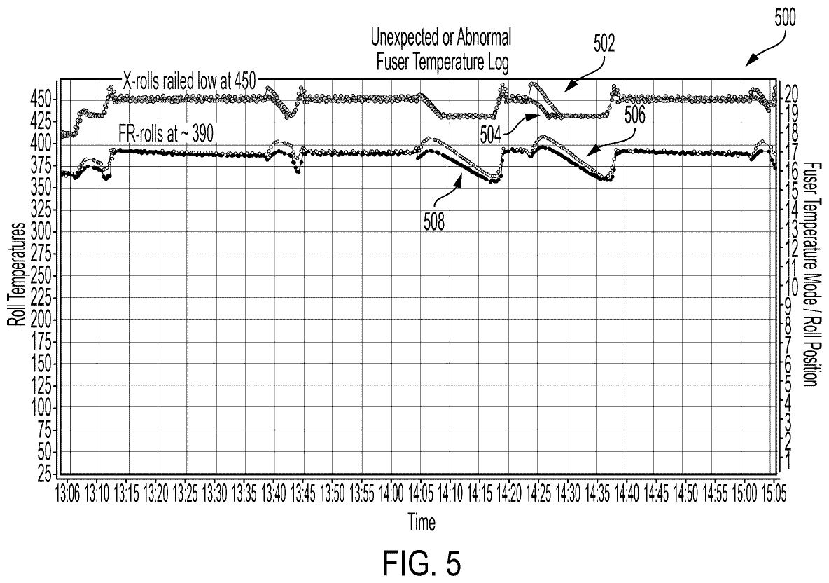

FIG. 5 provides a graph 500 showing a fuser temperature log in a scenario where thick paper is being printed on by machine 102. Line 502 plots temperature readings for heating roller (X-Roll 1) 146, while line 504 plots temperature readings for heating roller (X-Roll 2) 148. Heating roller (X-Roll 2) 148 has a tendency to run cooler than heating roller (X-Roll 1) 146. Line 506 plots FR OB temperature readings for fuser roller 134, while line 508 plots FR IB temperature readings for fuser roller 134.

In thick paper print mode, the temperature of the fuser roller 134 should be about 385° F. and the temperature of the heating rollers 146, 148 should be about 470° F. However, the temperature of the fuser roller 134 is at 390° F. (i.e., above its set point) when the heating rollers 146, 148 are at their lower control limit of 450° F. This should not happen and therefore indicates a fuser fault. Therefore, the system may conclude that the temperature sensors 140 of heating rollers 146, 148 should be cleaned.

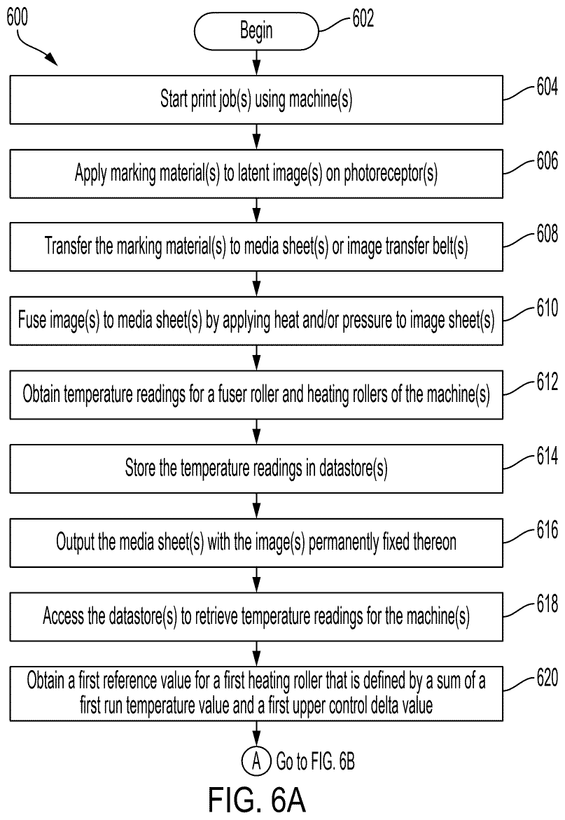

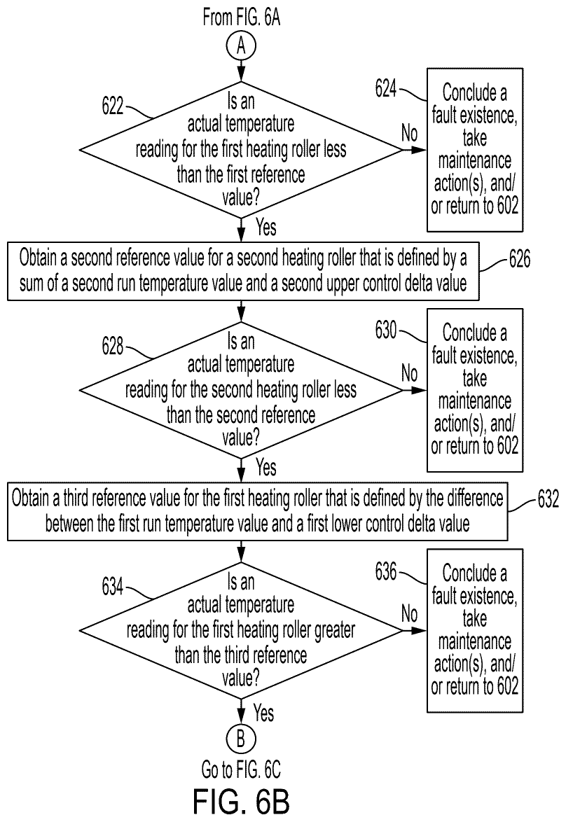

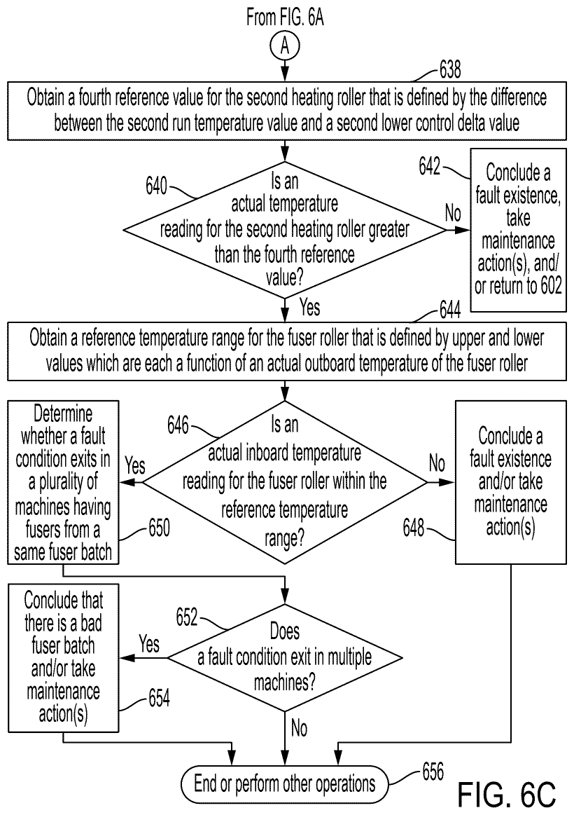

FIG. 6 provides a flow diagram of an illustrative method 600 for operating a system in accordance with the present solution. Method 600 may be implemented by system 100 of FIG. 1. Method 600 can include more or less operations than that shown in FIG. 6. Additionally or alternatively, the operations of method 600 may be performed in a different order than that shown. For example, the relative arrangement of operations in blocks 620-624, operations in blocks 626-630, operations in blocks 632-636, operations in blocks 638-642, and/or operations in blocks 644-648 may be changed such that the temperature analysis for the heating rollers and fuser roller are performed in a different order than that shown.

Method 600 begins with block 602 and continues to block 604 where a print job is started using machine(s) (e.g., machine(s) 102 of FIG. 1). In the scenario where the machine(s) is(are) xerographic device(s), method 600 continues with 606 where marking material(s) is(are) applied on photoreceptor(s) (e.g., photoreceptor(s) 104 of FIG. 1). Next in block 608, the marking material(s) is(are) transferred to media sheet(s) or image transfer block(s). The image(s) is(are) fused in block 610 to the media sheet(s) by applying heat and/or pressure to the image sheet(s). Temperature readings are made during the printing operations by temperature sensors (e.g., temperature sensors 140 of FIG. 1) of fuser roller(s) 134 and heating rollers 146, 148. The temperature readings are stored in datastore(s) (e.g., datastore(s) 142, 144 of FIG. 1) as shown by block 614. The media sheet(s) with the image(s) permanently fixed thereon is(are) output in block 616.

In block 618, a controller (e.g., controller 130 of FIG. 1) and/or a computing device (e.g., computing device 150 of FIG. 1) perform(s) operations to access datastore(s) (e.g., datastore(s) 142 and/or 144 of FIG. 1) and retrieve temperature readings for the machine(s). The controller and/or computing device obtained in block 620 a first reference value R1 for a first heating roller (e.g., heating roller 146 of FIG. 1). The first reference value R1 is a function of a first run temperature value T_{XR1runtemp} and a first upper control delta value T_{XR1uppercontroldelta}. The first reference value R1 may be defined by following mathematical equation (6)

$$R 1 = {T}_{XR 1 runtemp} + {T}_{XR 1 uppercontroldelta} \qquad ( 6 )$$

Thereafter, method 600 continues to block 622 of FIG. 6B.

As shown in FIG. 6B, block 622 involves determining whether an actual temperature reading for the first heating roller T_{XR1actual} is less than the first reference value R1. This determination operation may be performed by the controller and/or computing device. This determination operation may be defined by the following mathematical equation (7).

$${T}_{XR 1 actual} < R 1 \qquad ( 7 )$$

If not [622: NO], then method 622 continues to block 624 where the controller and/or computing device concludes a fault existence, takes one or more maintenance actions, and/or returns to block 602. The maintenance actions taken in block 624 can include any maintenance action(s) mentioned in this document. For example, the controller and/or computing device may (i) raise a flag, (ii) log a fault, (iii) notify or alert a service representative or technician that the fuser 128 in particular machine(s) should be serviced, (iv) transition an operational state of the machine 102 from an ON state to an OFF state or from a print mode to a standby mode, (v) enabling a self-cleaning mode of the fuser 128 for automatically cleaning the temperature sensor(s) 140 of at least the fuser roller (e.g., fuser roller 134 of FIG. 1), (vi) automatically checking and/or changing the nip width (i.e., distance(s) between heating roller(s) and fuser roller), and/or (vii) automatically replacing the temperature sensor(s) 140 of at least the fuser roller (e.g., by switching out sensors from a circuit and switching in sensors to the circuit, and/or moving sensors away from the fuser roller and moving other sensors close the fuser roller).

If so [622: YES], then method 622 continues to block 626 where the controller and/or computing device obtain a second reference value R2 for a second heating roller. The second reference value R2 is a function of a second run temperature value T_{XR2runtemp} and a second upper control delta value T_{XR2uppercontroldelta}. The second reference value R2 may be defined by following mathematical equation (8).

$$R 2 = {T}_{XR 2 runtemp} + {T}_{XR 2 uppercontroldelta} \qquad ( 8 )$$

Next in block 628, the controller and/or computing device involves determining whether an actual temperature reading for the second heating roller T_{XR2actual} is less than the second reference value R2. This determination operation may be performed by the controller and/or computing device. This determination operation may be defined by the following mathematical equation (9).

$${T}_{XR 2 actual} < R 2 \qquad ( 9 )$$

If not [628: NO], then method 622 continues to block 630 where the controller and/or computing device concludes a fault existence, takes one or more maintenance actions, and/or returns to block 602. The maintenance actions taken in block 630 can include any maintenance action(s) mentioned in this document. For example, the controller and/or computing device may (i) raise a flag, (ii) log a fault, (iii) notify or alert a service representative or technician that the fuser 128 in particular machine(s) should be serviced, (iv) transition an operational state of the machine 102 from an ON state to an OFF state or from a print mode to a standby mode, (v) enabling a self-cleaning mode of the fuser 128 for automatically cleaning the temperature sensor(s) 140 of at least the fuser roller (e.g., fuser roller 134 of FIG. 1), (vi) automatically checking and/or changing the nip width (i.e., distance(s) between heating roller(s) and fuser roller), and/or (vii) automatically replacing the temperature sensor(s) 140 of at least the fuser roller (e.g., by switching out sensors from a circuit and switching in sensors to the circuit, and/or moving sensors away from the fuser roller and moving other sensors close the fuser roller).

If so [628: YES], then method 622 continues to block 632 where the controller and/or computing device obtain a third reference value R3 for the first heating roller. The third reference value R3 is a function of the first run temperature value T_{XR1runtemp} and a first lower control delta value T_{XR1lowercontroldelta}. The third reference value R2 may be defined by following mathematical equation (10).

$$R 3 = {T}_{XR 1 runtemp} - {T}_{XR 1 lowercontroldelta} \qquad ( 10 )$$

Next in block 634, the controller and/or computing device involves determining whether an actual temperature reading for the first heating roller T_{XR1actual} is greater than the third reference value R3. This determination operation may be performed by the controller and/or computing device. This determination operation may be defined by the following mathematical equation (11).

$${T}_{XR 1 actual} > R 3 \qquad ( 11 )$$

If not [634: NO], then method 600 continues to block 636 where the controller and/or computing device concludes a fault existence, takes one or more maintenance actions, and/or returns to block 602. The maintenance actions taken in block 636 can include any maintenance action(s) mentioned in this document. For example, the controller and/or computing device may (i) raise a flag, (ii) log a fault, (iii) notify or alert a service representative or technician that the fuser 128 in particular machine(s) should be serviced, (iv) transition an operational state of the machine 102 from an ON state to an OFF state or from a print mode to a standby mode, (v) enabling a self-cleaning mode of the fuser 128 for automatically cleaning the temperature sensor(s) 140 of the fuser roller (e.g., fuser roller 134 of FIG. 1) and/or heating roller(s) (e.g., heating roller 146, 148 of FIG. 1), and/or (vi) automatically replacing the temperature sensor(s) 140 of the fuser roller and heating rollers (e.g., by switching out sensors from a circuit and switching in sensors to the circuit, and/or moving sensors away from a roller and moving other sensors close a roller).

If so [634: YES], then method 600 continues to block 638 of FIG. 6C. Block 638 involves performing operations by the controller and/or computing device to obtain a fourth reference value R4 for the second heating roller. The fourth reference value R4 is a function of the second run temperature value T_{XR2runtemp} and a second lower control delta value T_{XR2lowercontroldelta}. The fourth reference value R4 may be defined by following mathematical equation (12).

$$R 4 = {T}_{XR 2 runtemp} - {T}_{XR 2 lowercontroldelta} \qquad ( 12 )$$

Next in block 640, the controller and/or computing device involves determining whether an actual temperature reading for the second heating roller T_{XR2actual} is greater than the fourth reference value R4. This determination operation may be performed by the controller and/or computing device. This determination operation may be defined by the following mathematical equation (13).

$${T}_{XR 2 actual} > R 4 \qquad ( 13 )$$

If not [640: NO], then method 600 continues to block 642 where the controller and/or computing device concludes a fault existence, takes one or more maintenance actions, and/or returns to block 602. The maintenance actions taken in block 642 can include any maintenance action(s) mentioned in this document. For example, the controller and/or computing device may (i) raise a flag, (ii) log a fault, (iii) notify or alert a service representative or technician that the fuser 128 in particular machine(s) should be serviced, (iv) transition an operational state of the machine 102 from an ON state to an OFF state or from a print mode to a standby mode, (v) enabling a self-cleaning mode of the fuser 128 for automatically cleaning the temperature sensor(s) 140 of the fuser roller (e.g., fuser roller 134 of FIG. 1) and/or heating roller(s) (e.g., heating roller 146, 148 of FIG. 1), and/or (vi) automatically replacing the temperature sensor(s) 140 of the fuser roller and heating rollers (e.g., by switching out sensors from a circuit and switching in sensors to the circuit, and/or moving sensors away from a roller and moving other sensors close a roller).

If so [640: YES], then method 600 continues to block 644 wherein the controller and/or computing device perform(s) operations to obtain a reference temperature range RTR for the fuser roller. The reference temperature range RTR is defined by upper and lower values L, U that are each a function of an actual onboard temperature T_{FROB} of the fuser roller. The reference temperature range RTR may be expressed by the following mathematical equations (14)-(16).

$$RTR = L to U \qquad ( 14 )$$

$$L = {T}_{FROB} - v \qquad ( 15 )$$

$$U = {T}_{FROB} + v \qquad ( 16 )$$

where v is a pre-defined or pre-specified number.

Next in block 646, the controller and/or computing device perform operation(s) to determine whether an actual inboard temperature reading T_{FRIB} for the fuser roller is within the reference temperature range RTR. This determination operation may be defined by the following mathematical equations (17).

$${T}_{FROB} - v \leq {T}_{FRIB} \leq {T}_{FROB} + v \qquad ( 17 )$$

If not [646: NO], then method 600 continues to block 648 where a conclusion is made that a fault exists and/or maintenance action(s) is(are) taken. The maintenance actions taken in block 648 can include any maintenance action(s) mentioned in this document. For example, the controller and/or computing device may (i) raise a flag, (ii) log a fault, (iii) notify or alert a service representative or technician that the fuser in particular machine(s) should be serviced, (iv) transition an operational state of the machine from an ON state to an OFF state or from a print mode to a standby mode, (v) enabling a self-cleaning mode of the fuser for automatically cleaning the temperature sensor(s) of the fuser roller (e.g., fuser roller 134 of FIG. 1), (vi) automatically replacing the temperature sensor(s) of the fuser roller (e.g., by switching out sensors from a circuit and switching in sensors to the circuit, and/or moving sensors away from a roller and moving other sensors close a roller), (vii) automatically check and/or adjust a nip width (or distance) between each heating roller and the fuser roller, and/or (viii) automatically verify that the heating elements of the heating roller(s) are operating properly. Subsequently, method 600 continues to block 656 where it ends or other operations are performed (e.g., return to block 602 of FIG. 6A).

If so [646: YES], then method 600 continues to block 650 where the controller and/or computing device determines whether a fault condition exists in a plurality of machines having fusers from a same fuser batch. A fuser batch comprises a group of fuser that were manufactured together during a single production run. When a fault condition exits in multiple machines [652: YES], the controller and/or computing device conclude in block 654 that there is a bad fuser batch and/or take(s) maintenance action(s). The maintenance action(s) taken in block 654 can include any maintenance action(s) mentioned in this document. For example, the controller and/or computing device may (i) raise a flag, (ii) log a fault, (iii) notify or alert a service representative or technician that a particular fuser batch is bad, (iv) transition an operational state of the machine from an ON state to an OFF state or from a print mode to a standby mode, (v) automatically replace the fusers in the machines associated with the bad fuser batch. Otherwise [652: NO], method 600 continues to block 656 where it ends or other operations are performed (e.g., return to block 602 of FIG. 6A).

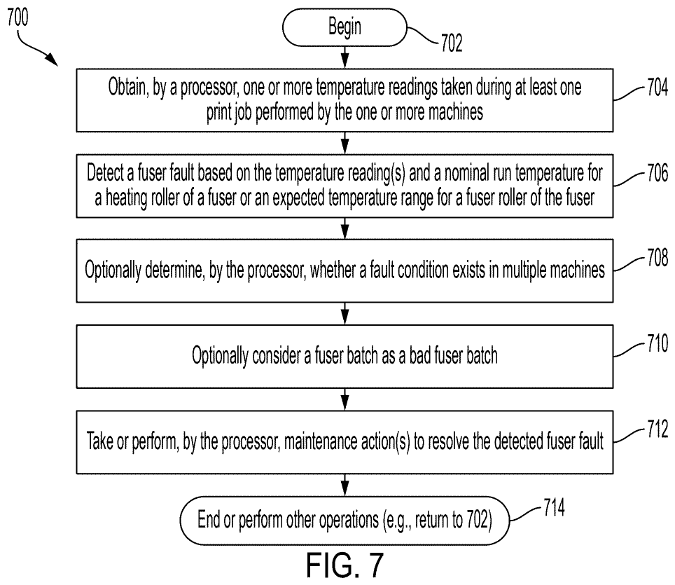

FIG. 7 provides a flow diagram of an illustrative method 700 for a system (e.g., system 100 of FIG. 1) including a plurality of machines (e.g., machines 102 of FIG. 1) having fusers (e.g., fusers 128 of FIG. 1) installed therein. Method 700 begins at block 702 and continues to block 704 where a processor (e.g., a processor of controller 130 and/or computing device 150 of FIG. 1) performs operations to obtain one or more temperature readings taken during at least one print job performed by the machine(s). These operations can include, but are not limited to, accessing datastore(s) and retrieving data therefrom.

Next in block 706, the processor performs operations to detect a fuser fault based on (1) the temperature reading(s) and (2) a nominal run temperature for a heating roller of a fuser or an expected temperature range for a fuser roller of the fuser. This detection may be made by determining whether an actual temperature reading for the heating roller is less than, equal to or greater than a first reference value. The first reference value may be a function of (i) the run temperature for the heating roller and (ii) an upper or lower control delta value associated with the heating roller. The first reference value is (1) a sum of the run temperature for the heating roller and the upper control delta value or (2) a difference between the run temperature for the heating roller and the lower control delta value. The fuser fault may be detected when the actual temperature reading is greater than the first reference value that is a function of the upper lower control delta, or when the actual temperature reading is less than the first reference value that is a function of the lower control delta value. Additionally or alternatively, the detection may be made by determining whether an inboard temperature of the fuser roller falls within a reference temperature range that is a function of an outboard temperature of the fuser roller. The reference temperature range may have a lower limit comprising a difference between the outboard temperature and a value and an upper limit comprising a sum of the outboard temperature and the value.

In optional blocks 708-710, the processor performs operations to: determine whether a fault condition exists in two or more of the machines which have fusers from a given fuser batch; and consider the fuser batch as being a bad fuser batch.

In block 712, the processor performs operations to take maintenance action(s) to resolve the detected fuser fault. The maintenance action may comprise: notifying or alerting an individual that the fuser should be serviced; transitioning an operational state of the one or more machines from an ON state to an OFF state or from a print mode to a standby mode; enabling a self-cleaning mode of the fuser to initiate operations for cleaning temperature sensor(s) of the fuser; automatically changing a distance between the heating roller and the fuser roller; and/or automatically adjusting alignment between the heating roller and the fuser roller. The self-cleaning mode operations may comprise: increasing a temperature of the fuser roller; adjusting a rotational speed of the fuser roller and/or the heating roller; automatically moving one or more temperature sensors into a media path through the fuser; running a thick sheet of media through the fuser to clean one or more temperature sensors in the media path; and/or controlling an automatic sensor cleaner for cleaning the temperature sensor(s) associated with the fuser roller and/or the heating roller. The maintenance action may additionally or alternatively comprise: switching out a temperature sensor from a fuser circuit and switching in another temperature sensor into the fuser circuit; and/or (re)calibrating the fuser by shifting up or down nominal or expected temperatures for the fuser roller or the heating roller; and/or enabling a software function configured to add and/or subtract given value(s) from temperature readings of the fuser roller or heating roller. Subsequently, method 700 continues to block 714 where it ends or other operations are performed (e.g., return to 702).

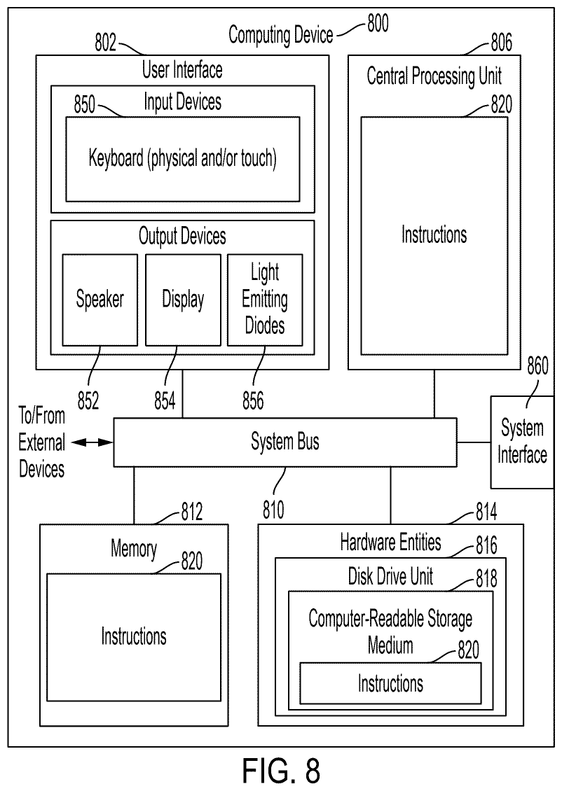

Referring now to FIG. 8, there is shown an illustrative architecture for a computing device 800. The controller 130 of FIG. 1 and computing device 150 of FIG. 1 is/are the same as or similar to computing device 800. As such, the discussion of computing device 800 is sufficient for understanding the controller 130 of FIG. 1 and/or computing device 150 of FIG. 1.

Computing device 800 may include more or less components than those shown in FIG. 8. However, the components shown are sufficient to disclose an illustrative solution implementing the present solution. The hardware architecture of FIG. 8 represents one implementation of a representative computing device configured to receive information, process the receive information, transmit information and/or control operations of an aerial vehicle, as described herein. As such, the computing device 800 of FIG. 8 implements at least a portion of the method(s) described herein.

Some or all components of the computing device 800 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 8, the computing device 800 comprises a user interface 802, a Central Processing Unit (CPU) 806, a system bus 810, a memory 812 connected to and accessible by other portions of computing device 800 through system bus 810, a system interface 860, and hardware entities 814 connected to system bus 810. The user interface can include input devices and output devices, which facilitate user-software interactions for controlling operations of the computing device 800. The input devices include, but are not limited to, a physical and/or touch keyboard 850. The input devices can be connected to the computing device 800 via a wired or wireless connection (e.g., a Bluetooth® connection). The output devices include, but are not limited to, a speaker 852, a display 854, and/or light emitting diodes 856. System interface 860 is configured to facilitate wired or wireless communications to and from external devices (e.g., network nodes such as access points, etc.).

At least some of the hardware entities 814 perform actions involving access to and use of memory 812, which can be a Random Access Memory (RAM), a disk drive, flash memory, and/or another hardware device that is capable of storing instructions and data. Hardware entities 814 can include a disk drive unit 816 comprising a computer-readable storage medium 818 on which is stored one or more sets of instructions 820 (e.g., software code) configured to implement one or more of the methodologies, procedures, or functions described herein. The instructions 820 can also reside, completely or at least partially, within the memory 812 and/or within the CPU 806 during execution thereof by the computing device 800. The memory 812 and the CPU 806 also can constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding or carrying a set of instructions 820 for execution by the computing device 800 and that cause the computing device 800 to perform any one or more of the methodologies of the present disclosure.

In view of the forgoing, the present solution concerns an implementing system and a method for operating a system (e.g., system 100 of FIG. 1) including a plurality of machines (e.g., machines 102 of FIG. 1). The method comprises: obtaining, by a processor, one or more temperature readings taken during at least one print job performed by the one or more machines; detecting, by the processor, a fuser fault based on the one or more temperature readings and at least one of a nominal run temperature for a heating roller of a fuser and an expected temperature range for a fuser roller of the fuser; and taking, by the processor, a maintenance action to resolve the detected fuser fault.

The detecting operation may comprise determining whether an actual temperature reading for the heating roller is less than, equal to or greater than a first reference value, the first reference value being a function of (i) the run temperature for the heating roller and (ii) an upper or lower control delta value associated with the heating roller. The first reference value may be (1) a sum of the run temperature for the heating roller and the upper control delta value or (2) a difference between the run temperature for the heating roller and the lower control delta value. The fuser fault may be detected when the actual temperature reading is greater than the first reference value that is a function of the upper lower control delta, or when the actual temperature reading is less than the first reference value that is a function of the lower control delta value.

The detecting operation may additionally or alternatively comprise determining whether an inboard temperature of the fuser roller falls within a reference temperature range that is a function of an outboard temperature of the fuser roller. The reference temperature range may have a lower limit comprising a difference between the outboard temperature and a value and an upper limit comprising a sum of the outboard temperature and the value.

The method may also comprise: determining, by the processor, whether a fault condition exists in two or more of the machines which have fusers from a given fuser batch; and considering, by the processor, the fuser batch as being a bad fuser batch.

The maintenance action may include, but is not limited to: notifying or alerting an individual that the fuser should be serviced; transitioning an operational state of the one or more machines from an ON state to an OFF state or from a print mode to a standby mode; enabling a self-cleaning mode of the fuser to initiate operations for cleaning temperature sensor(s) of the fuser; automatically changing a distance between the heating roller and the fuser roller; and/or automatically adjusting alignment between the heating roller and the fuser roller. The self-cleaning mode operations may include, but are not limited to: increasing a temperature of the fuser roller; adjusting a rotational speed of the fuser roller and/or the heating roller; automatically moving one or more temperature sensors into a media path through the fuser; running a thick sheet of media through the fuser to clean one or more temperature sensors in the media path; and/or controlling an automatic sensor cleaner for cleaning the temperature sensor(s) associated with the fuser roller and/or the heating roller. The maintenance action may alternatively or additionally comprise: switching out a temperature sensor from a fuser circuit and switching in another temperature sensor into the fuser circuit; and/or (re)calibrating the fuser by shifting up or down nominal or expected temperatures for the fuser roller or the heating roller; and/or enabling a software function configured to add and/or subtract given value(s) from temperature readings of the fuser roller or heating roller.

The present solution also concerns a system, comprising: one or more machines having fusers installed therein and temperature sensors that take temperature readings during print or copy jobs; a processor; and a non-transitory computer-readable medium comprising one or more programming instructions. The programming instructions, when executed by the processor, cause the processor to: obtain one or more temperature readings taken during at least one print job performed by the one or more machines; detect a fuser fault based on the one or more temperature readings and at least one of a nominal run temperature for a heating roller of a fuser and an expected temperature range for a fuser roller of the fuser; and take a maintenance action to resolve the detected fuser fault.

The fuser fault may be detected based on a determination as to whether an actual temperature reading for the heating roller is less than, equal to or greater than a first reference value, the first reference value being a function of (i) the run temperature for the heating roller and (ii) an upper or lower control delta value associated with the heating roller. The first reference value may be (1) a sum of the run temperature for the heating roller and the upper control delta value or (2) a difference between the run temperature for the heating roller and the lower control delta value.

The fuser fault may additionally or alternatively be detected when the actual temperature reading is greater than the first reference value that is a function of the upper lower control delta, or when the actual temperature reading is less than the first reference value that is a function of the lower control delta value. The fuser fault may be detected based on a determination whether an inboard temperature of the fuser roller falls within a reference temperature range that is a function of an outboard temperature of the fuser roller. The reference temperature range may have a lower limit comprising a difference between the outboard temperature and a value and an upper limit comprising a sum of the outboard temperature and the value.

The processor may also be caused to: determine whether a fault condition exists in two or more of the machines which have fusers from a given fuser batch; and consider the fuser batch as being a bad fuser batch.

The maintenance action can include, but is not limited to: notifying or alerting an individual that the fuser should be serviced; transitioning an operational state of the one or more machines from an ON state to an OFF state or from a print mode to a standby mode; enabling a self-cleaning mode of the fuser to initiate operations for cleaning temperature sensor(s) of the fuser; automatically changing a distance between the heating roller and the fuser roller; and/or automatically adjusting alignment between the heating roller and the fuser roller. The self-cleaning mode operations may include, but are not limited to: increasing a temperature of the fuser roller; adjusting a rotational speed of the fuser roller and/or the heating roller; automatically moving one or more temperature sensors into a media path through the fuser; running a thick sheet of media through the fuser to clean one or more temperature sensors in the media path; and/or controlling an automatic sensor cleaner for cleaning the temperature sensor(s) associated with the fuser roller and/or the heating roller. The maintenance action can additionally or alternatively comprise: switching out a temperature sensor from a fuser circuit and switching in another temperature sensor into the fuser circuit; and/or (re)calibrating the fuser by shifting up or down nominal or expected temperatures for the fuser roller or the heating roller; and/or enabling a software function configured to add and/or subtract given value(s) from temperature readings of the fuser roller or heating roller.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for operating a system including one or more machines, comprising:
obtaining, by a processor, one or more temperature readings taken during at least one print job performed by the one or more machines;
detecting, by the processor, a fuser fault based on the one or more temperature readings and at least one of a nominal run temperature for a heating roller of a fuser and an expected temperature range for a fuser roller of the fuser; and
taking, by the processor, a maintenance action to resolve the detected fuser fault.

2. The method according to claim 1, wherein the detecting comprises determining whether an actual temperature reading for the heating roller is less than, equal to or greater than a first reference value, the first reference value being a function of (i) the run temperature for the heating roller and (ii) an upper or lower control delta value associated with the heating roller.

3. The method according to claim 2, wherein the first reference value is (1) a sum of the run temperature for the heating roller and the upper control delta value or (2) a difference between the run temperature for the heating roller and the lower control delta value.

4. The method according to claim 2, wherein the fuser fault is detected when the actual temperature reading is greater than the first reference value that is a function of the upper lower control delta, or when the actual temperature reading is less than the first reference value that is a function of the lower control delta value.

5. The method according to claim 1, wherein the detecting comprises determining whether an inboard temperature of the fuser roller falls within a reference temperature range that is a function of an outboard temperature of the fuser roller.

6. The method according to claim 5, wherein the reference temperature range has a lower limit comprising a difference between the outboard temperature and a value and an upper limit comprising a sum of the outboard temperature and the value.

7. The method according to claim 1, further comprising:
determining, by the processor, whether a fault condition exists in two or more of the machines which have fusers from a given fuser batch; and
considering, by the processor, the given fuser batch as being a bad fuser batch.

8. The method according to claim 1, wherein the maintenance action comprises: notifying or alerting an individual that the fuser should be serviced; transitioning an operational state of the one or more machines from an ON state to an OFF state or from a print mode to a standby mode; enabling a self-cleaning mode of the fuser to initiate operations for cleaning temperature sensor(s) of the fuser; automatically changing a distance between the heating roller and the fuser roller; and/or automatically adjusting alignment between the heating roller and the fuser roller.

9. The method according to claim 1, wherein self-cleaning mode operations comprise: increasing a temperature of the fuser roller; adjusting a rotational speed of the fuser roller and/or the heating roller; automatically moving one or more temperature sensors into a media path through the fuser; running a thick sheet of media through the fuser to clean one or more temperature sensors in the media path; and/or controlling an automatic sensor cleaner for cleaning temperature sensor(s) associated with the fuser roller and/or the heating roller.

10. The method according to claim 1, wherein the maintenance action comprises: switching out a temperature sensor from a fuser circuit and switching in another temperature sensor into the fuser circuit; and/or (re)calibrating the fuser by shifting up or down nominal or expected temperatures for the fuser roller or the heating roller; and/or enabling a software function configured to add and/or subtract given value(s) from temperature readings of the fuser roller or heating roller.

11. A system, comprising:
one or more machines having fusers installed therein and temperature sensors that take temperature readings during print or copy jobs;
a processor; and
a non-transitory computer-readable medium comprising one or more programming instructions that when executed by the processor, cause the processor to:
obtain one or more temperature readings taken during at least one print job performed by the one or more machines;
detect a fuser fault based on the one or more temperature readings and at least one of a nominal run temperature for a heating roller of a fuser and an expected temperature range for a fuser roller of the fuser; and
take a maintenance action to resolve the detected fuser fault.

12. The system according to claim 11, wherein the fuser fault is detected based on a determination as to whether an actual temperature reading for the heating roller is less than, equal to or greater than a first reference value, the first reference value being a function of (i) the nominal run temperature for the heating roller and (ii) an upper or lower control delta value associated with the heating roller.

13. The system according to claim 12, wherein the first reference value is (1) a sum of the nominal run temperature for the heating roller and the upper control delta value or (2) a difference between the nominal run temperature for the heating roller and the lower control delta value.

14. The system according to claim 12, wherein the fuser fault is detected when the actual temperature reading is greater than the first reference value that is a function of the upper lower control delta, or when the actual temperature reading is less than the first reference value that is a function of the lower control delta value.

15. The system according to claim 11, wherein the fuser fault is detected based on a determination as to whether an inboard temperature of the fuser roller falls within a reference temperature range that is a function of an outboard temperature of the fuser roller.

16. The system according to claim 15, wherein the reference temperature range has a lower limit comprising a difference between the outboard temperature and a value and an upper limit comprising a sum of the outboard temperature and the value.

17. The system according to claim 11, wherein the processor is further caused to:
determine whether a fault condition exists in two or more of the machines which have fusers from a given fuser batch; and
consider the given fuser batch as being a bad fuser batch.

18. The system according to claim 11, wherein the maintenance action comprises: notifying or alerting an individual that the fuser should be serviced; transitioning an operational state of the one or more machines from an ON state to an OFF state or from a print mode to a standby mode; enabling a self-cleaning mode of the fuser to initiate operations for cleaning temperature sensor(s) of the fuser; automatically changing a distance between the heating roller and the fuser roller; and/or automatically adjusting alignment between the heating roller and the fuser roller.

19. The system according to claim 11, wherein self-cleaning mode operations comprise: increasing a temperature of the fuser roller; adjusting a rotational speed of the fuser roller and/or the heating roller; automatically moving one or more temperature sensors into a media path through the fuser; running a thick sheet of media through the fuser to clean one or more temperature sensors in the media path; and/or controlling an automatic sensor cleaner for cleaning temperature sensor(s) associated with the fuser roller and/or the heating roller.

20. The system according to claim 11, wherein the maintenance action comprises: switching out a temperature sensor from a fuser circuit and switching in another temperature sensor into the fuser circuit; and/or (re)calibrating the fuser by shifting up or down nominal or expected temperatures for the fuser roller or the heating roller; and/or enabling a software function configured to add and/or subtract given value(s) from temperature readings of the fuser roller or heating roller.
